(19) United States
(12) Patent Application Publication
(10) Pub. No.: US 2025/0317094 A1
(43) Pub. Date: Oct. 9, 2025

(54) APPARATUS, SYSTEM, AND METHODS FOR MODULAR SOLAR RACKING SYSTEM

(71) Applicant: Paul W. Budge, St. George, UT (US)

(72) Inventor: Paul W. Budge, St. George, UT (US)

(21) Appl. No.: 19/172,552

(22) Filed: Apr. 7, 2025

Related U.S. Application Data
(60) Provisional application No. 63/731,143, filed on Apr. 5, 2024.

(51) Int. Cl. H02S 30/10; H02S 20/10

(52) U.S. Cl. CPC H02S 30/10; H02S 20/10

(57) ABSTRACT

Support frames are disclosed for use in a solar module racking system. In certain examples, the support frame includes a bottom connecting member provided with an aperture for adjustably receiving a spacing member, a first vertical support member vertically disposed on a first end of the bottom connecting member and having a mounting mechanism for connecting to a panel, and a second vertical member vertically disposed opposite the first vertical support member on a second end of the bottom connecting member parallel to the first vertical support member and spaced apart from the first vertical support member. The second vertical support member is provided with a mounting mechanism for connecting to the panel.

### CROSS-REFERENCES TO RELATED APPLICATIONS

This application claims the benefit of U.S. Provisional Patent Application No. 63/731,143 entitled “APPARATUS, SYSTEM, AND METHOD FOR STRUCTURAL SOLAR RACKING SYSTEM WITH EARTH BALLAST AND EARTH SPIKE GROUND MOUNTING CAPABILITY” and filed on Apr. 5, 2024, for Paul W. Budge, which is incorporated herein by reference.

### FIELD

This disclosure relates generally to modular, self-supporting mounting systems of solar modules, and in particular, modular self-supporting racking devices for mounting solar modules on a variety of surfaces.

### BACKGROUND

As solar energy becomes more popular, so do new ways to attach solar panels to different surfaces, like rooftops or the ground. Over time, these systems have been improved to make them easier and faster to install. However, some challenges remain, especially when setting up or relocating a solar panel system. For example, many current systems are made up of numerous components, which can make installation slow and tricky.

Solar panels are used to create electricity for homes and businesses. Since one panel can only produce a small amount of electricity, several panels are usually grouped together to form a system. Even though there are many systems available to secure solar panels, they often have significant downsides. Some systems are expensive to make or take a long time to install. Others might require custom parts to fit specific types of panels, which makes the process more complicated. Some systems require extensive construction costs for various footing and securement types.

Because of these challenges, there's still a lot of room to create better mounting systems for solar panels—systems that are more affordable, easier to install, relocateable, and eco-friendly.

### SUMMARY

Apparatuses are disclosed for use in a solar module racking system. In some examples, a support frame includes a bottom connecting member provided with an aperture for adjustably receiving a spacing member, a first vertical support member vertically disposed on a first end of the bottom connecting member and having a mounting mechanism for connecting to a panel, and a second vertical support member vertically disposed opposite the first vertical support member on a second end of the bottom connecting member parallel to the first vertical support member and spaced apart from the first vertical support member, the second vertical support member having a mounting mechanism for connecting to the panel.

In some examples, the panel of the support frame includes a solar panel. In other examples, the support frame includes a first support frame and a second support frame and the spacing member is connectable between the first support frame and the second support frame such that distance between the first support frame and the second support frame is adjustable. In some examples, the spacing member is secured to the first support frame and the second support frame such that the distance between the first support frame and the second support frame is the width of the panel.

In some examples, the bottom connecting member further includes at least one aperture of the first end of the bottom connecting member adapted for securing the support frame to a ground surface and at least one aperture of the second end of the bottom connecting member is adapted for securing the support frame to the ground surface. In some examples, the at least one aperture of the first end is coupled to a first earth anchor wherein the first earth anchor is secured to the ground surface and the at least one aperture of the second end is coupled to a second earth anchor wherein the second earth anchor is secured to the ground surface. In some examples, the at least one aperture of the first end and the at least one aperture of the second end includes a series of ridges along an inside each of the apertures to further couple the bottom connecting member to the first earth anchor and second earth anchor. In some examples, the support frame includes a first support frame and a second support frame where the spacing member is coupled between the first support frame and the second support frame such that distance between the first support frame and the second support frame the width of the panel.

In some examples, the support frame further includes a non-woven geofabric tightened across the spacing member and the geofabric is coupled to the first support frame and the second support frame with an adhesive. In some examples, a layer of earth is applied across the top of the geofabric.

In some examples, the bottom connecting member, the first vertical support member, and the second vertical support member are tubular. In some examples, the bottom connecting member, the first vertical support member, and the second vertical support member made of a metal composite.

In some examples, a reconfigurable solar panel system, includes at least one solar panel and a plurality of repeating frames coupled to each side of the at least one solar panel. Each of the repeating frames includes a bottom connecting member provided with an aperture for adjustably receiving a spacing member, a first vertical support member vertically disposed on a first end of the bottom connecting member and having a mounting mechanism for connecting to a panel, and a second vertical support member vertically disposed opposite the first vertical support member on a second end of the bottom connecting member parallel to the first vertical support member and spaced apart from the first vertical support member, the second vertical support member having a mounting mechanism for connecting to the panel.

In some examples, the spacing member of the reconfigurable solar panel system is coupled between a first repeating frame and a second repeating frame such that a distance between the first repeating frame and the second repeating frame is a width of the at least one solar panel. In some examples, the bottom connecting member of the plurality of repeating frames also includes at least one aperture of a first end of the bottom connecting member adapted for securing the support frame to a ground surface and at least one aperture of a second end of the bottom connecting member is adapted for securing the support frame to the ground surface. In some examples, the at least one aperture of the first end is coupled to a first earth anchor wherein the first earth anchor is secured to the ground surface and the at least one aperture of the second end is coupled to a second earth anchor wherein the second earth anchor is secured to the ground surface. In some examples, the at least one aperture of the first end and the at least one aperture of the second end having a series of ridges along an inside each of the apertures to further couple the bottom connecting member to the first earth anchor and second earth anchor.

In some examples, the plurality of repeating frames includes a flexible sheet tightened across the spacing member and the flexible sheet is coupled to the first support frame and the second support frame. In some examples a layer of earth is applied across the top of the flexible sheet.

In some examples, the reconfigurable solar panel system includes at least one solar panel, a plurality of repeating frames coupled to each side of the at least one solar panel. Each of the repeating frames may include a bottom connecting member provided with an aperture for adjustably receiving a spacing member. A first vertical support member is vertically disposed on a first end of the bottom connecting member and the first vertical support member has a mounting mechanism for connecting to a panel. A second vertical support member is vertically disposed opposite the first vertical support member on a second end of the bottom connecting member parallel to the first vertical support member and spaced apart from the first vertical support member. The second vertical support member having a mounting mechanism for connecting to the solar panel. The reconfigurable solar panel system may further include a spacing member connectable between the plurality of repeating frames such that the distance between a first repeating frame and a second repeating frame a width of the solar panel. The system includes a non-woven geofabric tightened across the plurality of repeating frames and the spacing member. The non-woven geofabric is coupled to the plurality of repeating frames with an adhesive and a layer of earth is applied across the top of the non-woven geofabric.

### BRIEF DESCRIPTION OF THE DRAWINGS

In order that the advantages of the invention will be readily understood, a more particular description of the invention briefly described above will be rendered by reference to specific embodiments that are illustrated in the appended drawings. Understanding that these drawings depict only typical embodiments of the invention and are not therefore to be considered to be limiting of its scope, the invention will be described and explained with additional specificity and detail through the use of the accompanying drawings, in which:

FIG. 1 is a perspective view illustrating a solar panel racking frame, according to one or more examples disclosed herein;

FIG. 2 is a perspective view illustrating a solar panel racking frame, according to one or more examples disclosed herein;

FIG. 3 is a perspective view illustrating a support frame, according to one or more examples disclosed herein;

FIG. 4 is an exploded view illustrating a support frame, according to one or more examples disclosed herein;

FIG. 5 is a perspective view illustrating a bottom connecting member of a support frame, according to one or more examples disclosed herein;

FIG. 6 is a close-up perspective view illustrating a portion of a bottom connecting member of FIG. 5;

FIG. 7 is close-up perspective view of a portion of a support frame, according to one or more examples disclosed herein;

FIG. 8 is an exploded view illustrating a support frame, according to one or more examples disclosed herein;

FIG. 9 is an exploded view illustrating a solar panel racking frame, according to one or more examples disclosed herein;

FIG. 10 is a rear perspective view illustrating a solar panel racking frame, according to one or more examples disclosed herein;

FIG. 11 is a rear perspective view illustrating a solar panel racking frame and solar panel, according to one or more examples disclosed herein;

FIG. 12 is an exploded perspective view of a multi-panel racking frame, according to one or more examples disclosed herein;

FIG. 13 is a perspective view of a multi-panel racking frame, according to one or more examples disclosed herein;

FIG. 14 is a rear perspective view of a multi-panel racking frame, according to one or more examples disclosed herein;

FIG. 15 is a rear view of a multi-panel racking frame, according to one or more examples disclosed herein;

FIG. 16 is a perspective view of an extended racking frame, according to one or more examples disclosed herein;

FIG. 17 a perspective view of an extended racking support frame, according to one or more examples disclosed herein;

FIG. 18 is a side view of an extended racking support frame, according to one or more examples disclosed herein;

FIG. 19 a perspective view of an extended racking support frame, according to one or more examples disclosed herein;

FIG. 20 is a perspective view of a multi-panel extended racking frame, according to one or more examples disclosed herein;

FIG. 21 is a perspective view of an adjustable support frame, according to one or more examples disclosed herein;

FIG. 22 is a side view of an adjustable support frame, according to one or more examples disclosed herein;

FIG. 23 is a perspective view of an adjustable support frame, according to one or more examples disclosed herein;

FIG. 24 is a side view of an adjustable racking frame, according to one or more examples disclosed herein;

FIG. 25 is a rear perspective view of a multi-panel adjustable racking frame, according to one or more examples disclosed herein;

FIG. 26 is a perspective view of a multi-panel racking frame, according to one or more examples disclosed herein;

FIG. 27 is a perspective view of securing a multi-panel racking frame, according to one or more examples disclosed herein;

FIG. 28 is a rear perspective view of securing a multi-panel racking frame, according to one or more examples disclosed herein;

FIG. 29 is a rear view of securing a multi-panel racking frame, according to one or more examples disclosed herein;

FIG. 30 is a perspective view of a portion of a support frame, according to one or more examples disclosed herein;

FIG. 31 illustrates a spike used with a racking frame, according to one or more examples disclosed herein;

FIG. 32 is a rear view of a multi-panel racking frame, according to one or more examples disclosed herein;

FIG. 33 is a rear perspective view of a multi-panel racking frame, according to one or more examples disclosed herein;

FIG. 34 is a rear view of securing a multi-panel racking frame, according to one or more examples disclosed herein;

FIG. 35 is a rear view of securing a multi-panel racking frame, according to one or more examples disclosed herein; and

FIG. 36 is a rear view of securing a multi-panel racking frame, according to one or more examples disclosed herein.

### DETAILED DESCRIPTION

Reference throughout this specification to “one example,” “an example,” or similar language means that a particular feature, structure, or characteristic described in connection with the example is included in at least one example of the present disclosure. Appearances of the phrases “in one example,” “in an example,” and similar language throughout this specification may, but do not necessarily, all refer to the same example. Similarly, the use of the term “implementation” means an implementation having a particular feature, structure, or characteristic described in connection with one or more examples of the present disclosure, however, absent an express correlation to indicate otherwise, an implementation may be associated with one or more examples.

Furthermore, the described features, structures, or characteristics of the invention may be combined in any suitable manner in one or more examples. In the following description, numerous specific details are provided, such as examples of mounting structures, adjustment mechanisms, materials, etc., to provide a thorough understanding of embodiments of the invention. One skilled in the relevant art will recognize, however, that the invention may be practiced without one or more of the specific details, or with other methods, components, materials, and so forth. In other instances, well-known structures, materials, or operations are not shown or described in detail to avoid obscuring aspects of the invention.

The description of elements in each figure may refer to elements of proceeding figures. Like numbers refer to like elements in all figures, including alternate embodiments of like elements.

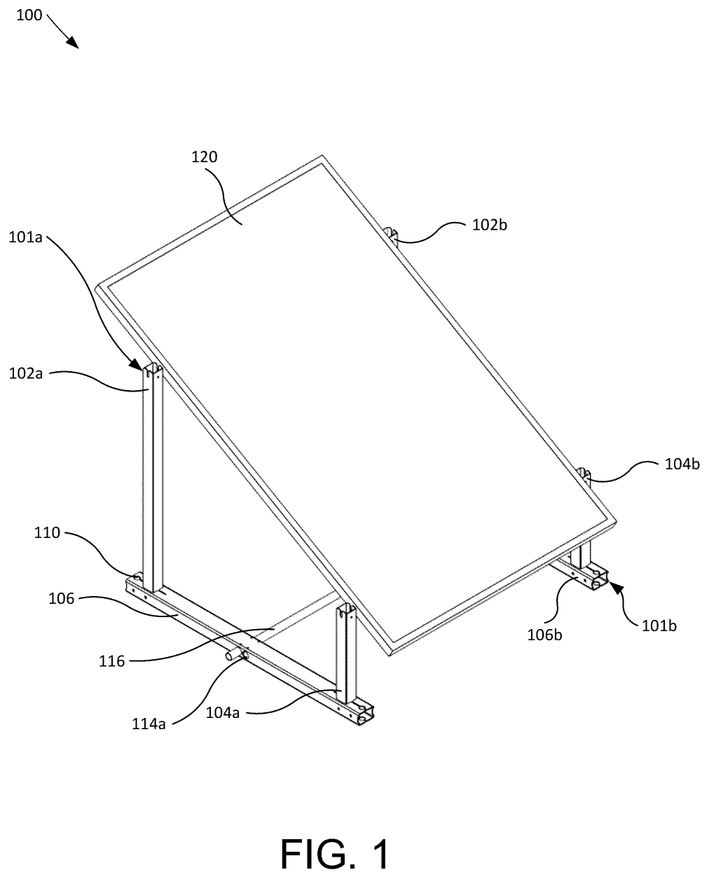

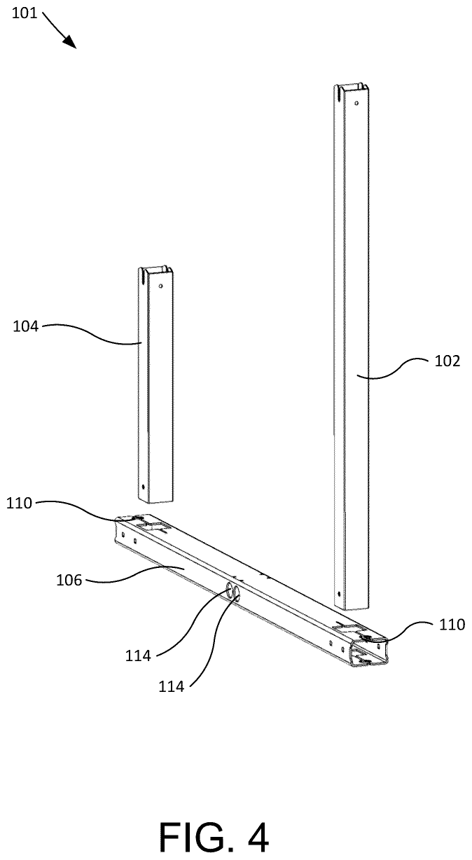

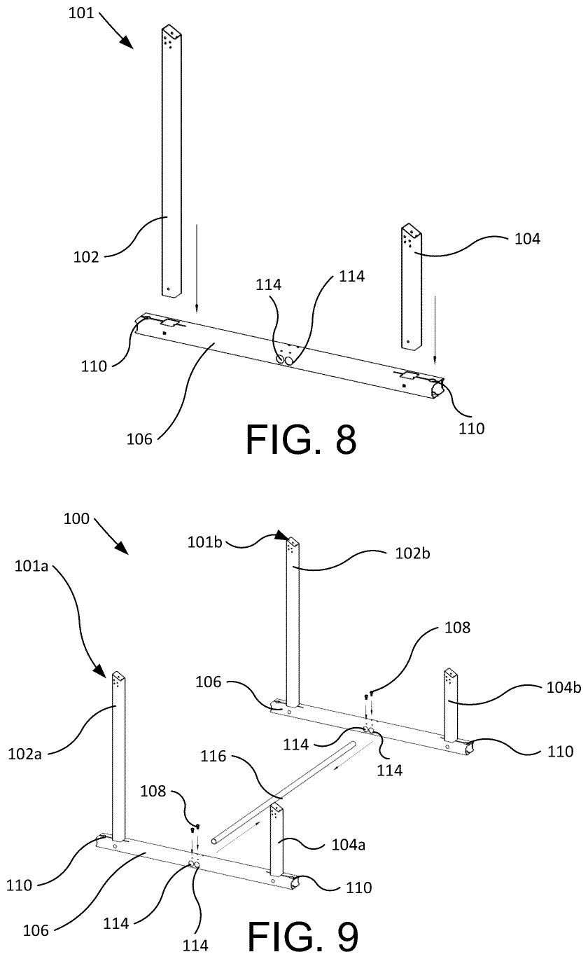

FIG. 1 illustrates a solar panel racking frame, according to one or more examples disclosed herein. A solar panel racking frame 100 includes a solar panel 120 and two support frames 101a and 101b, respectively, where the support frames 101a and 101b are spaced a distance equivalent to the width of the solar panel 120. Each support frame 101 is comprised of a bottom connecting member 106, a first vertical support member 102, and a second vertical support member 104 to form a U-shaped frame. In some examples, the support frame 101 is a multi-piece construction, having separate pieces for the bottom connecting member 106, the first vertical support member 102, and the second vertical support member 104, such that the support frame 101 can be assembled and disassembled. In some examples, the pieces (e.g. bottom connecting member 106, the first vertical support member 102, and the second vertical support member 104) are coupled to one another using fasteners or other attachment methods, as illustrated in FIGS. 4 and 8. In other examples, the pieces of the support frame 101 are welded together to form a one-piece construction. In yet another example, the pieces of the support frame 101 are co-formed to create a one-piece unit.

In some examples, the support frame 101 is composed of steel. In other examples, the support frame 101 is composed of aluminum. In yet another example, the support frame 101 is a composite plastic. In some examples, the support frame 101 is a metal or metal composite. In some examples, portions of the support frame 101 are composed of different materials. For example, the bottom connecting member 106 is made of steel and the first and second vertical support members are aluminum.

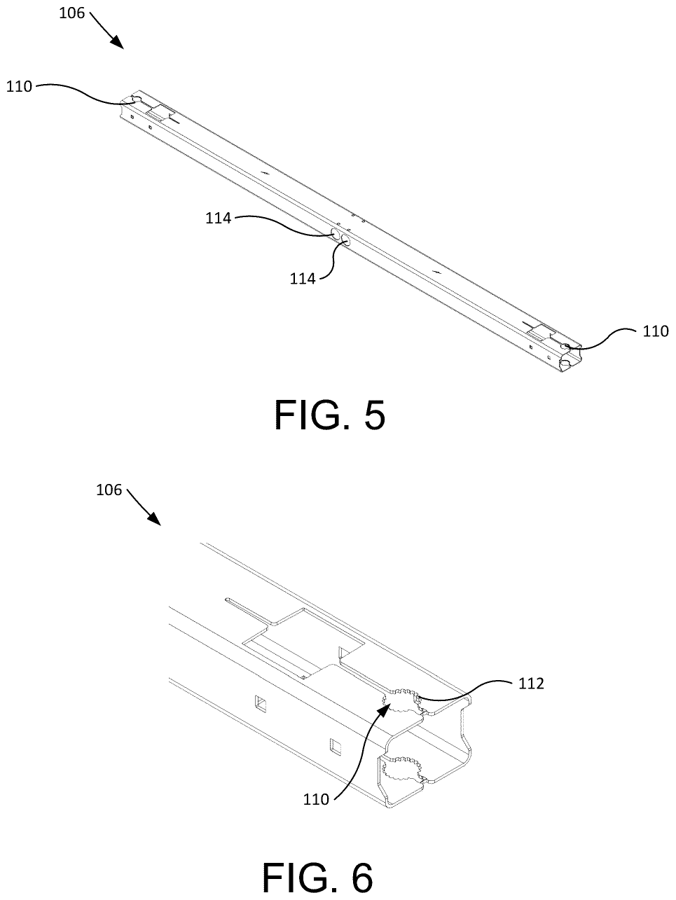

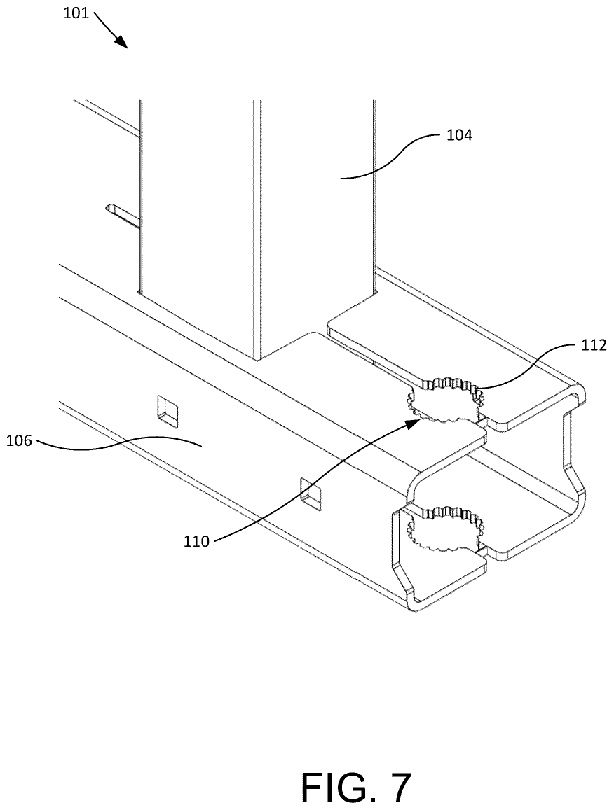

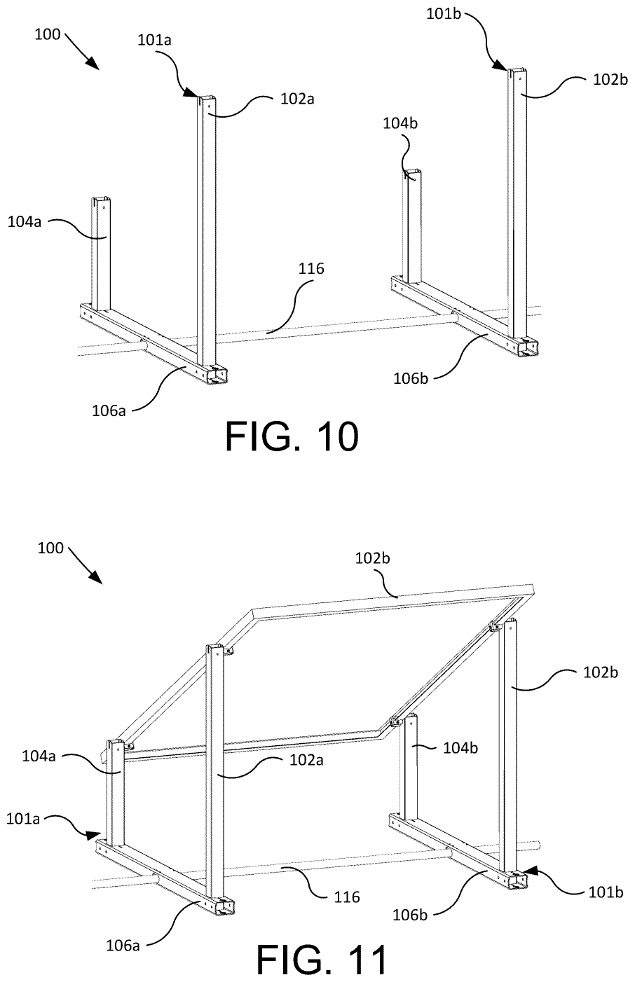

In some examples, the bottom connecting member 106 is tubular, as shown in FIGS. 1-15. In one example, the bottom connecting member 106 has a square or rectangular cross-section. FIGS. 5-8 illustrate one or more examples of the bottom connecting member 106. In some examples, the bottom connecting member 106 may include one or more spacing apertures 114 to couple to the spacing member 116. In some examples, the bottom connecting member 106 includes clamp apertures 110 on either end. In one example, the clamp apertures 110 are relatively circular in shape to clamp and secure to an earth anchor such as a bolt, spike 702, steel rod, small screw earth anchor, earth spike, barbed earth spike, or other anchoring mechanism. In one example, as shown in FIGS. 6-7, the clamp aperture 110 includes an array of ridges or teeth 112. The teeth 112 may provide extra friction to secure an earth anchor such as a bolt, spike 702, steel rod, or other anchoring mechanism. In some examples, the outermost point of the teeth 112 form a diameter smaller than the diameter of the earth anchor, such as a spike 702, bolt, steel rod, and the like, to better secure the bottom connecting member 106 to the spike 702, bolt, steel rod, or other anchor mechanisms. In some examples, the clamp aperture 110 may be used to level the support frame 101, and the solar racking frame 100, by adjusting the clamp aperture 110 up and down along an exposed portion of an earth spike, bolt, steel rod, or other anchor, until the system is level.

In some examples, as shown in at least FIGS. 1-15, a first vertical support member 102 is disposed at the first end of the bottom connecting member 106 and the second vertical support member 104 is disposed at the second end of the bottom connecting member 106. In some examples, the first vertical support member 102 is longer than the second vertical support member 104. In some examples, the first vertical support member 102 and the second vertical support member 104 are tubular. In some examples, the vertical support members 102 and 104 have a square or rectangular cross-section.

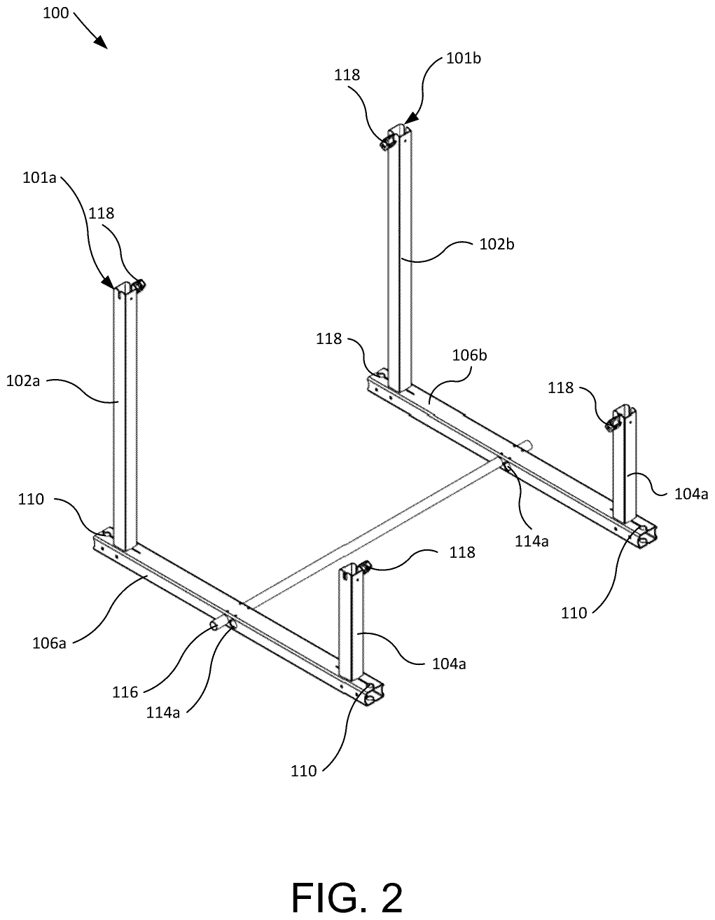

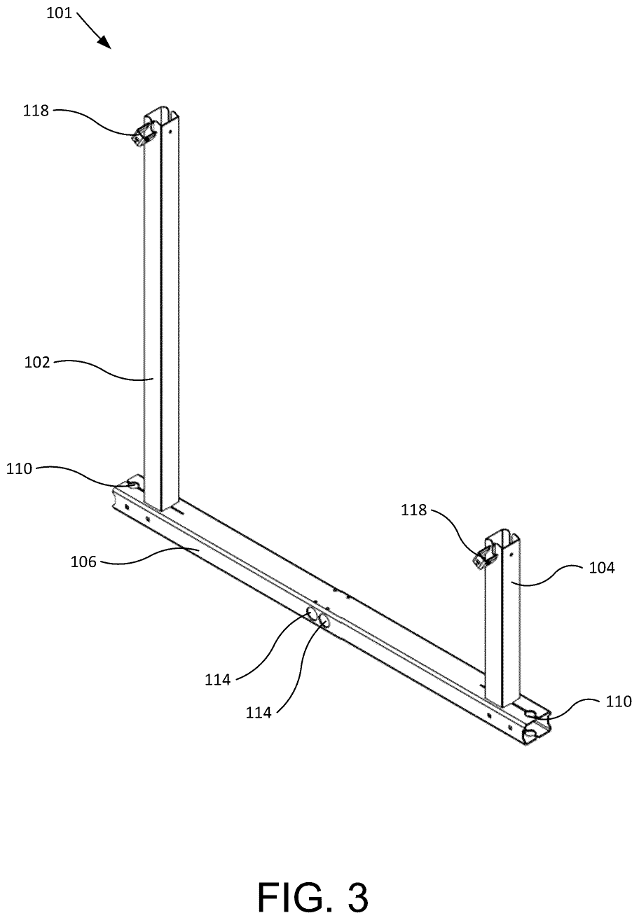

In some examples, the first vertical support member 102 and the second vertical support member 104 include a mounting mechanism 118 attached to the upper end of the vertical support members, 102 and 104 respectively, as shown in FIGS. 2-3. The mounting mechanism 118 is adapted to couple to a solar panel 120. While any suitable form of mounting mechanism is permissible, in some examples, the mounting mechanism 118 is a bracket. In some examples, the mounting mechanism 118 is adjustable to adapt to the exterior of the solar panel 120. In other examples, the mounting mechanism 118 is rotatably adjustable and provides minor angle adjustments to the solar panel 120 when attached to the support member 101. In some examples, the upper end of the vertical support members, 102 and 104 respectively, are shaped such that the vertical support members 102,104 are the mounting mechanism 118 for a solar panel 120. In some examples, the upper portion of the vertical support members 102,104 are angled to provide a fixed angle for a mounted solar panel 120. In other examples, as shown in FIGS. 2-3, a fixed angle for mounting a solar panel 120 is determined by the height difference of the first vertical support member 102 and the second vertical support member 104.

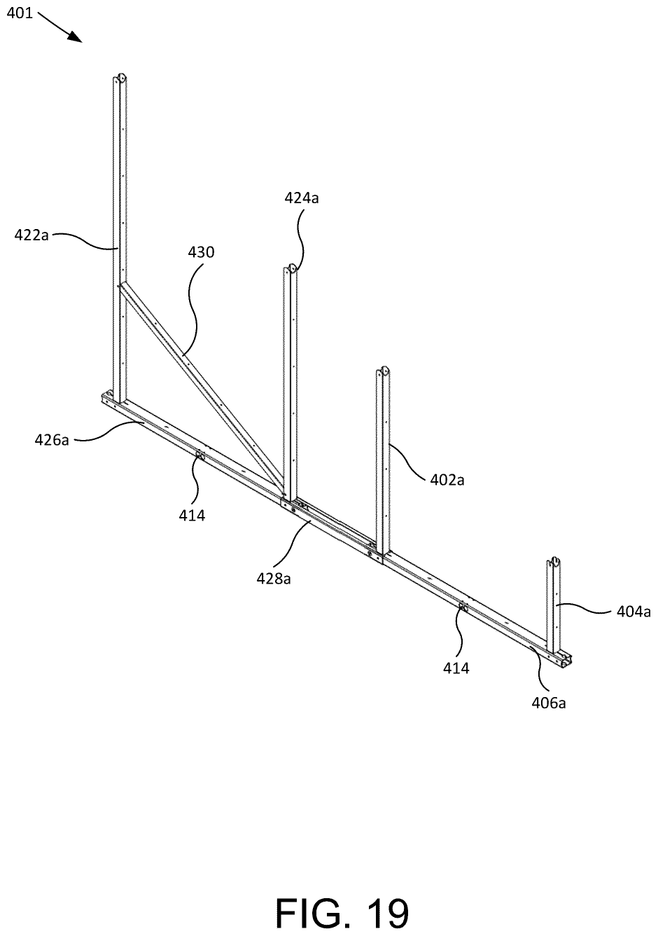

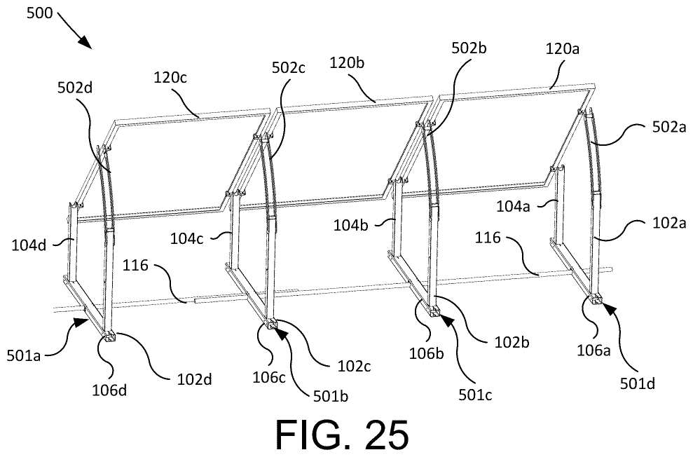

In some examples, the solar panel racking frame 100 includes a spacing member 116. The spacing member 116 couples to a spacing aperture 114 of the bottom connecting member 106. The spacing member 116 strengthens the support frame 101 and prevents the support frame 101 from rotating. In some examples, the spacing member 116 is a cylindrical rod, as shown in FIGS. 1-2, 9-15, 21, and 25-27. In some examples, the spacing member 116 is composed of a metal or metal composite. In some examples, the spacing member 116 is composed of steel. Alternatively, the spacing member 116 is composed of aluminum or a composite plastic. In some examples, the spacing member 116 is the width of a solar panel 120. In other examples, the spacing member 116 is longer than one or more solar panels 120, as shown in FIG. 11. In one example, the spacing member 116 extends beyond the supporting frames 101a and 101b such that there is additional length to space and connect three or more support frames 101 to one another. In some examples, as shown in FIG. 19, the spacing member 116 is secured to the support frames, 101a and 101b, by a fastener 108. In another example, the spacing member 116 is secured the spacing apertures 114 of the support frame 101 by an adhesive or epoxy. In some examples, the spacing member 116 is not fastened to the supporting frame but rather passes through the spacing aperture 114.

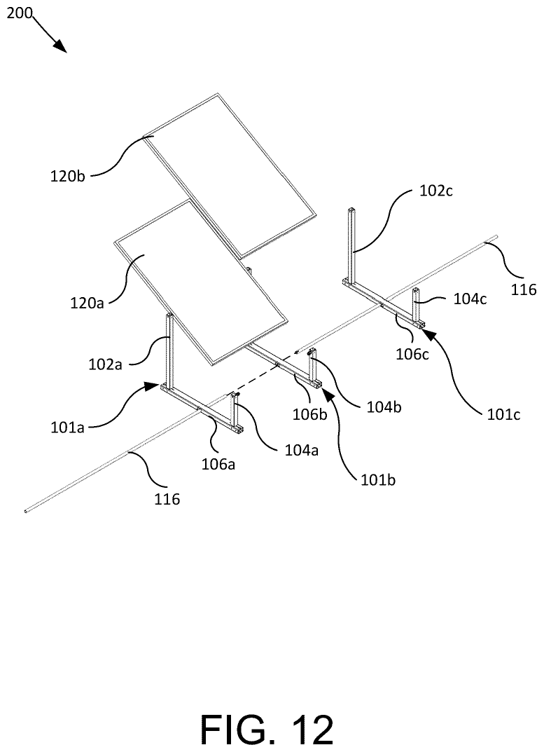

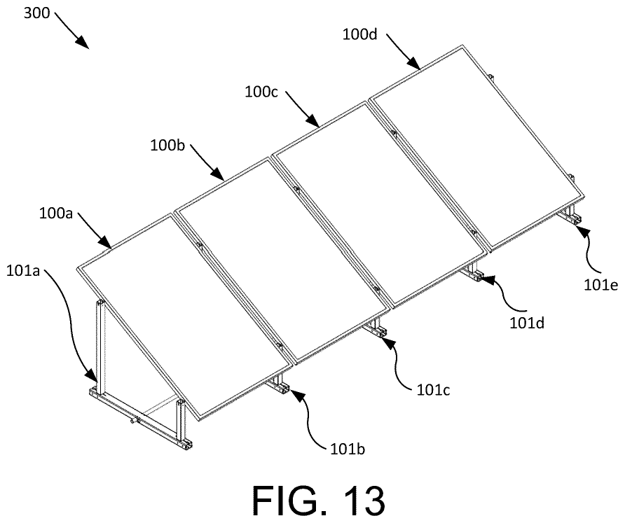

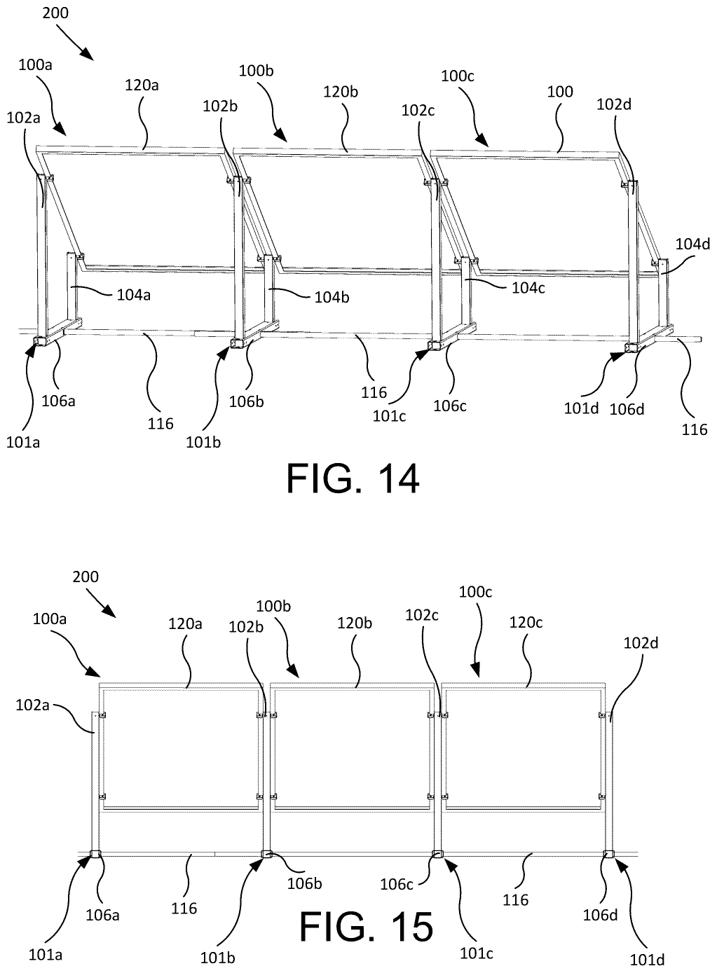

FIG. 12 illustrates an exploded perspective view of a multi-panel racking frame according to one or more examples. As shown in FIGS. 12-15, a multi-panel racking frame 200, 300 includes the number of solar panels 120, and the number of support frames 101 is the number of solar panels 120 plus one to create a full assembly. As shown in FIG. 12, for two solar panels 120a-b three support frames 101a-c are provided. For three solar panels 120a-c, four support frames 101a-d are provided, as shown in FIGS. 14-15. FIG. 13 illustrates a four solar panel 120a-d racking assembly 300 which requires five support frames 101a-e.

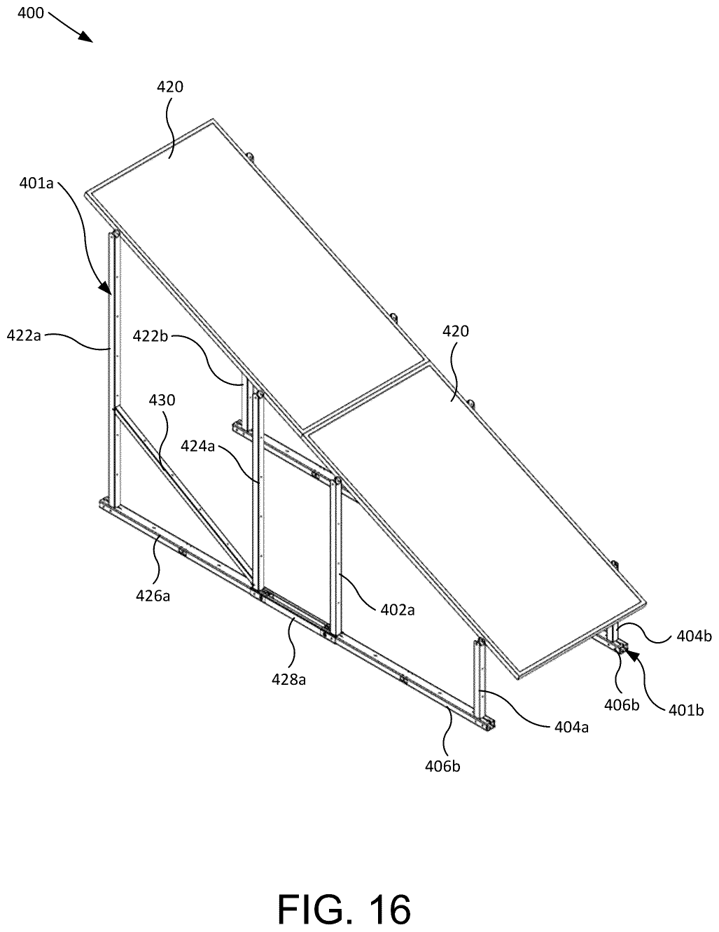

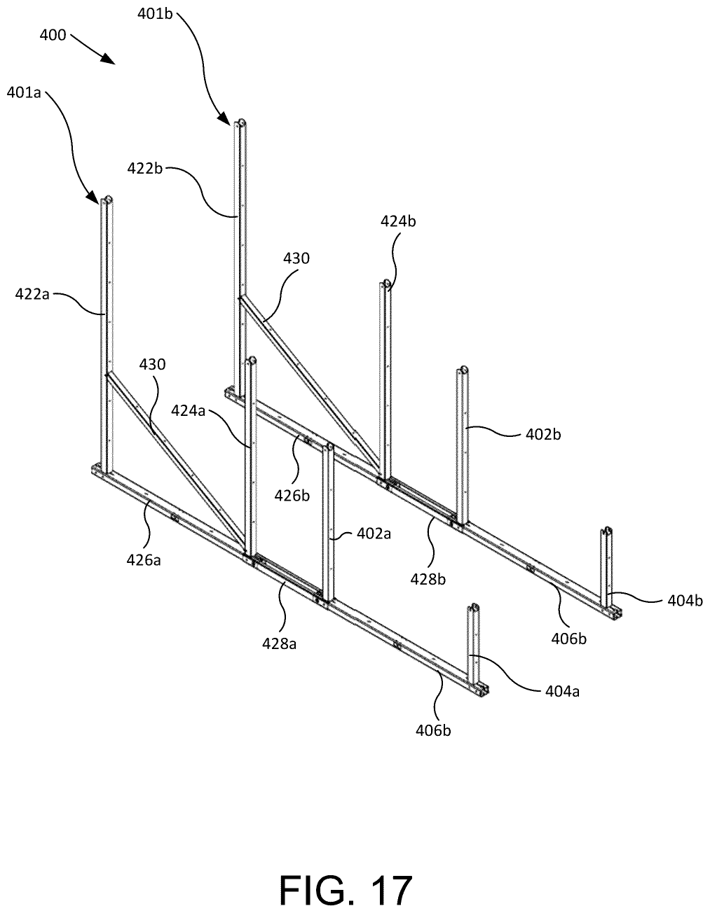

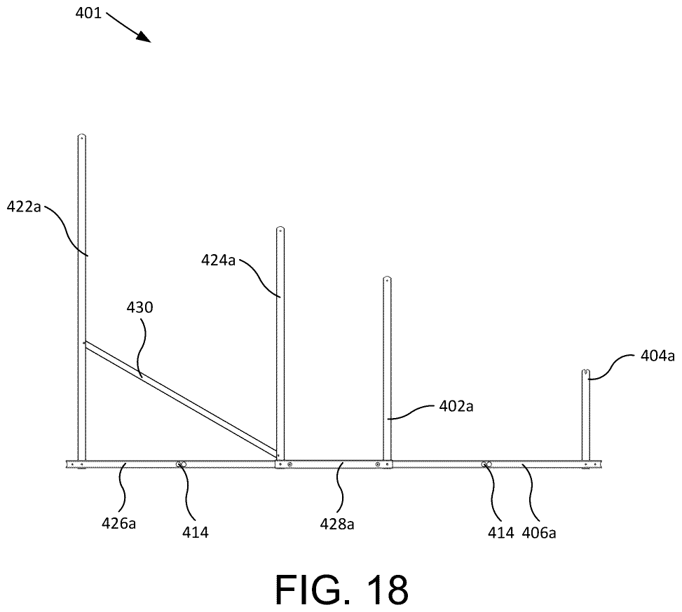

In some examples, a solar panel racking frame 400 is a larger or extended version of a solar panel racking 100 such that the extended solar racking frame 400 includes an extended support frame 401 for one or more solar panels 420, as shown in FIGS. 16, 17, and 20. In some examples, the extended support frame 401 includes four vertical support members, 402, 402, 422, and 424 respectively. In some examples, the vertical support members 402, 404, 422, and 424 are connected to a bottom frame member. In some examples, the bottom connecting member may include multiple parts such as a first bottom connecting member 406, a second bottom connecting member 426, and a bottom extension connecting member 428. In other examples, the bottom frame member is a one-piece construction. In some examples, as shown in FIGS. 17-18, the support frame 401 is a multi-piece construction. The first bottom connecting member 406 is similar in construction to the bottom connecting member 106. In some examples, the second bottom connecting member 426 is the same as the first connecting member 406. In other examples, the second bottom connecting member 426 is a larger version of the first bottom connecting member 406. In some examples, the larger version of the second bottom connecting member 426 is an extended or longer version of the first bottom connecting member 406. In some examples, the bottom connecting members 406 and 426 include one or more spacing apertures 414. Similar to the spacing apertures of 114, the spacing apertures 414 are shaped and sized to receive and couple to a spacing member 116. In some examples, the bottom connecting members 406 and 426, respectively, may include a clamp aperture 110. In other examples, the clamp aperture 110 includes the teeth 112 for securing to bolts, spikes 702, steel rods, or other anchor mechanism.

In some examples, the bottom extension connecting member 428 is a U-shaped, tubular member which connects a first bottom connecting member 406 to a second bottom connecting member 426 to form one long extended bottom frame member. In some examples, the bottom extension connecting member 428 is relatively short. In another example, the bottom extension connecting member 428 is the same length as the first and second connecting members, 406 and 426 respectively. In some examples, the extension connecting member 428 couples to the bottom connecting members 406 and 426 by using the clamp apertures 110. In some examples, the extension connecting member 428 couples to the bottom connecting members 406 and 426 with a fastener.

In some examples, the vertical support members 402 and 404 are disposed and secured to the ends of the first bottom connecting member 406, in a similar manner to support frame 101. The vertical support members 422 and 424 are disposed and secured to the ends of the second bottom connecting member 426.

In some examples, the four vertical support members 402, 404, 422, and 424, are tubular. In one example, the four vertical support members 402, 404, 422, and 424 are arranged to form a continuous angle, as shown in FIGS. 16-20. In one example, the four vertical support members, 402, 404, 422, and 424 are arranged to form a peak. In some examples, the vertical support members 422 and 424 are secured using a support cross bar 430. In some examples, the vertical support members 402, 404, 422, and 424 include a mounting mechanism 118 attached to the upper portion of the vertical support members 402, 404, 422, and 424. In alternative examples, the upper portion of the vertical support members 402, 404, 422, and 424, respectively, are shaped such that the vertical support members 402, 404, 422, and 424 are the mounting mechanism to create a fixed angle for solar panels 420.

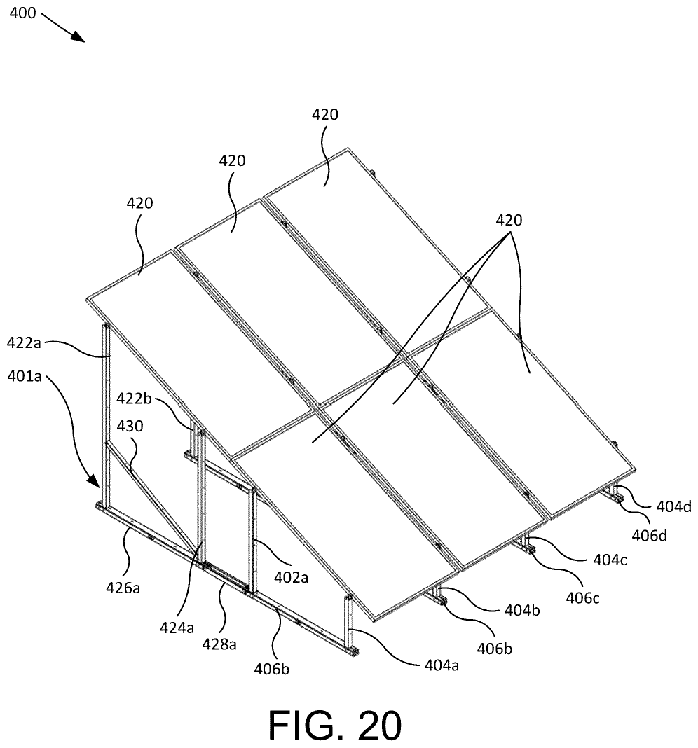

FIG. 20 illustrates a multi-panel extended racking frame 400. Similar to the multi-panel racking systems 200, 300, the extended racking frame 400 includes one more support frame 401 than the arrangement of solar panels. The example illustrated in FIG. 20, includes six solar panels 420 and four extended support frames 401. In another example, the four extended support frames 401 are coupled to three long solar panels.

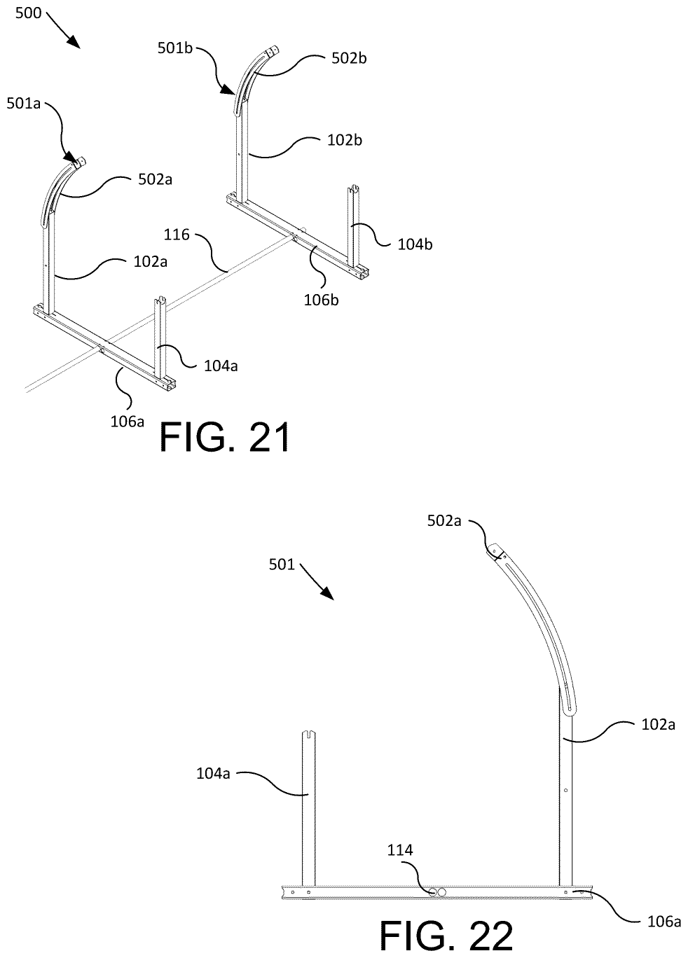

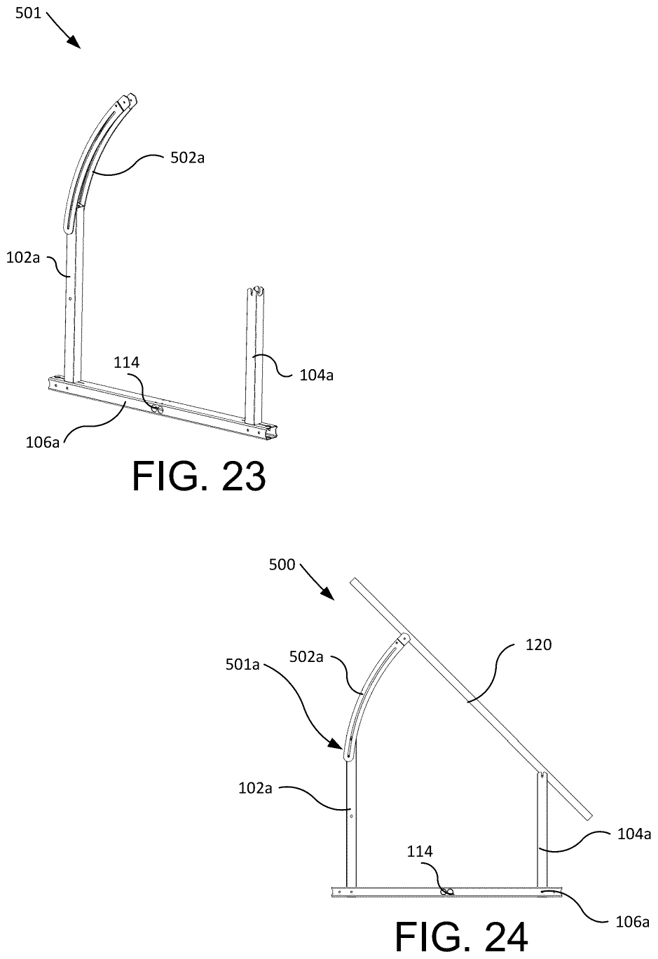

FIGS. 21-25 illustrate an adjustable racking frame 500, according to one or more examples. In some examples, an adjustable support frame 501 includes a bottom connecting member 106, a first vertical support member 102, and a second vertical support member 104. In some examples, a support frame 501 further includes an adjustable arm 502 coupled to the upper portion of the vertical supporting member 102. In some examples, the adjustable arm 502 modifies the racking angle of a mounted solar panel 120. In some examples, as shown in FIGS. 21-25, the adjustable arm 502 is a curved member. In some examples, the mounting mechanism 118 is attached to the upper portion of the adjustable arm 502. In some examples, the adjustable arm 502 includes a central channel for adjustments. In some examples, a fastener is disposed on the upper portion of the first vertical support member 102 and connects through the central channel of the adjustable arm 502.

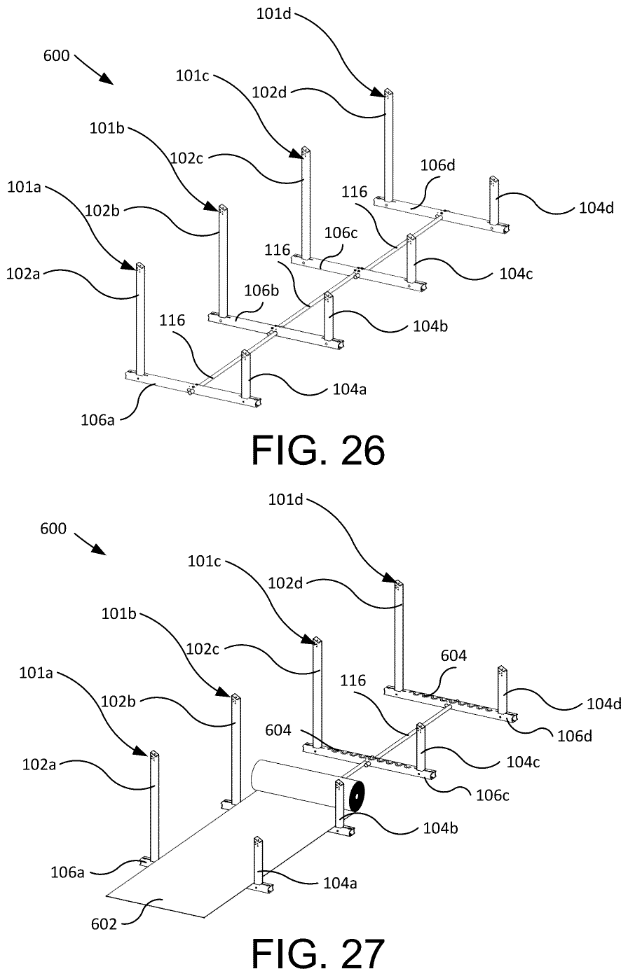

FIGS. 26-29 illustrate a method of securing a racking frame 600 to a ground or surface using an earth ballast. In some examples, a set of support frames 101a-d are secured and spaced apart using one or more spacing members 116. Once the set of support frames 101a-d are spaced to the appropriate width, which may be, for example, the width of the corresponding solar panel 120, an adhesive 604 may be applied to the top side of each of the bottom connecting members 106a-d of the support frames 101. In some examples, the adhesive 604 is an epoxy. In other examples, the adhesive is an epoxy composite. The adhesive 604 may also be omitted in further examples.

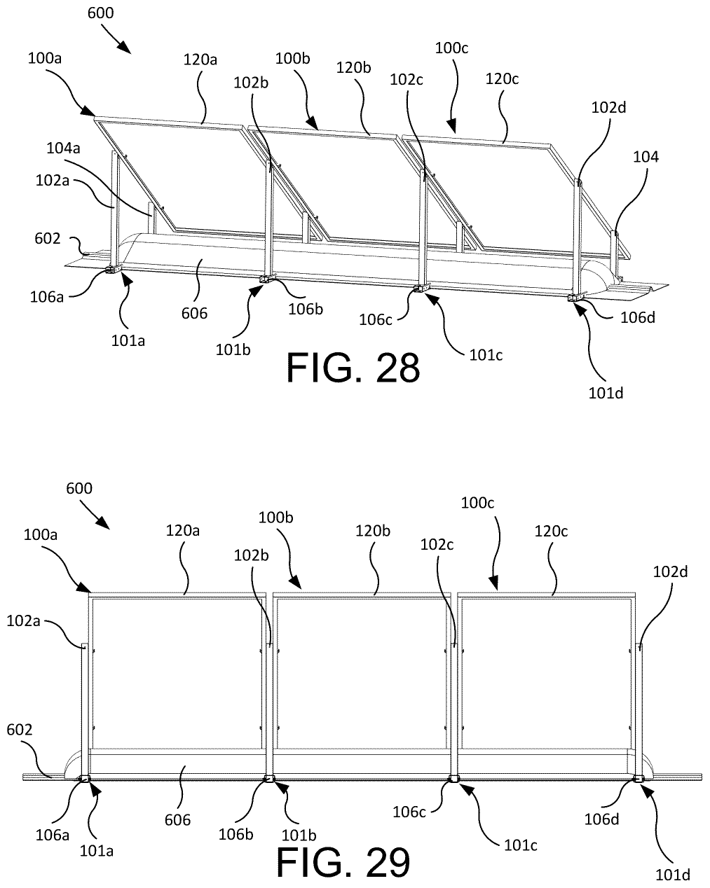

In some examples, a flexible sheet 602 is applied over the adhesive, as shown in FIG. 27, such that the flexible sheet 602 is suspended above a ground or flat surface. In some examples, the flexible sheet 602 is a geofabric, also referred to as a geotextile fabric, is a non-woven geotextile. In other examples, the flexible sheet 602 is a woven geotextile, a knitted geotextile, a spunbound geotextile, a needle-punched geotextile, or any alternative geotextile. The flexible sheet 602 is tensioned across the bottom connecting members 106a-d and the spacing members 116 such that the flexible sheet 602 is suspended above the ground. In some examples, the flexible sheet 602 is tensioned such that it resembles a trampoline. After the flexible sheet 602 is tensioned across the bottom connecting members 106a-d and spacing members 116, a layer of earth 606 is applied across the flexible sheet 602 to form a ballast, as shown in FIGS. 28-29. In some examples, the layer of earth 606 is a top soil or dirt. In other examples, the layer of earth 606 is a rock or gravel layer. In yet another example, the layer of earth 606 is a combination of dirt and rock combination. In other examples, the ballast may be any suitable material contained in bags or tubes.

In some examples, a flexible sheet 602 is applied over the support frames 101a-d without an adhesive 604. In some examples, the flexible sheet 602 is secured to one or more of the support frames 101a-d with a fastener and is tension across the bottom connecting members 106a-d and the spacing members 116 such that the flexible sheet 602 is suspended above the ground. In alternative examples, the flexible sheet 602 is secured to the ground, or flat surface, at a location beyond the outermost support frame 101 and tensioned across the bottom connecting members 106a-d and the spacing members 116 such that the flexible sheet 602 is suspended above the ground.

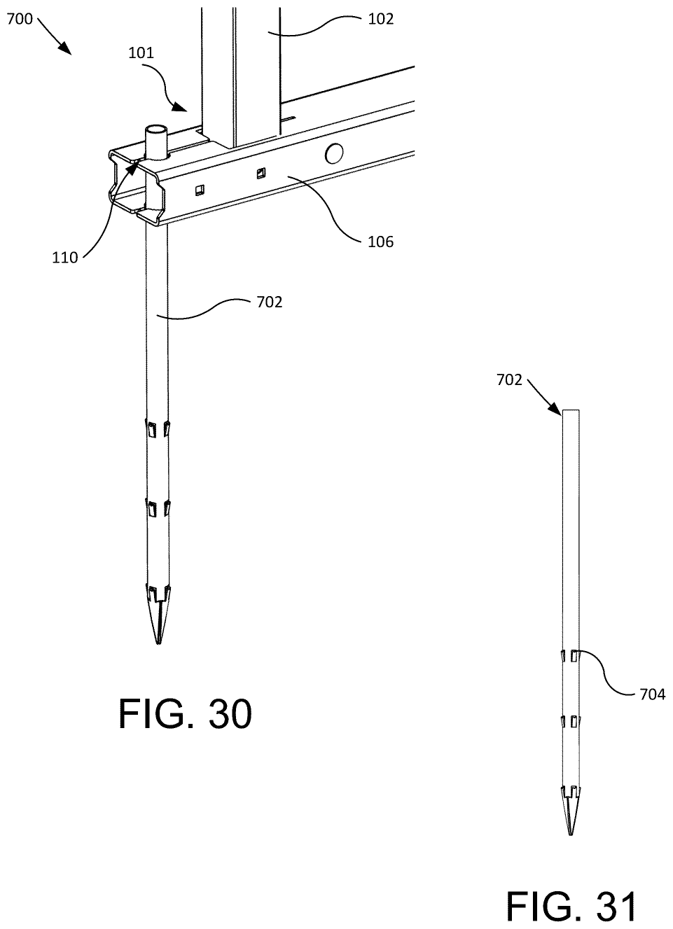

FIG. 30 illustrate securement methods of a bottom connecting member to a ground or surface using an earth anchor, according to one or more examples. In one example, system 700 includes at least one support frame 101 coupled to a earth anchor such as a spike 702. In some examples, as shown in FIG. 31, the spike 702 includes channels 704. In some examples, the channels 704 are triangular and allow an epoxy, resin, expanding foam or the like to extrude upwards out of the channels 704. As the resin, or the like, extrudes out of the channels 704, the resin will fill in any cavities surrounding the spike 702 within the ground surface. In some examples, an epoxy, resin, expanding foam, or the like, and may be injected into the top of the spike 702. The injected epoxy or resin may fill an internal cavity of spike 702 and extrude out of channels 704 into the surrounding dirt or surface. As the spike 702 fills, barbs are formed along the length of the earth spike allowing the resin to penetrate the surrounding soil and fill voids surrounding the earth spike. The resin cures to form bulges or nodes of hardened resin, resulting in a strong anchor. This type of earth spike eliminates the need to spend years compacting the soil around the base of the support frame 101.

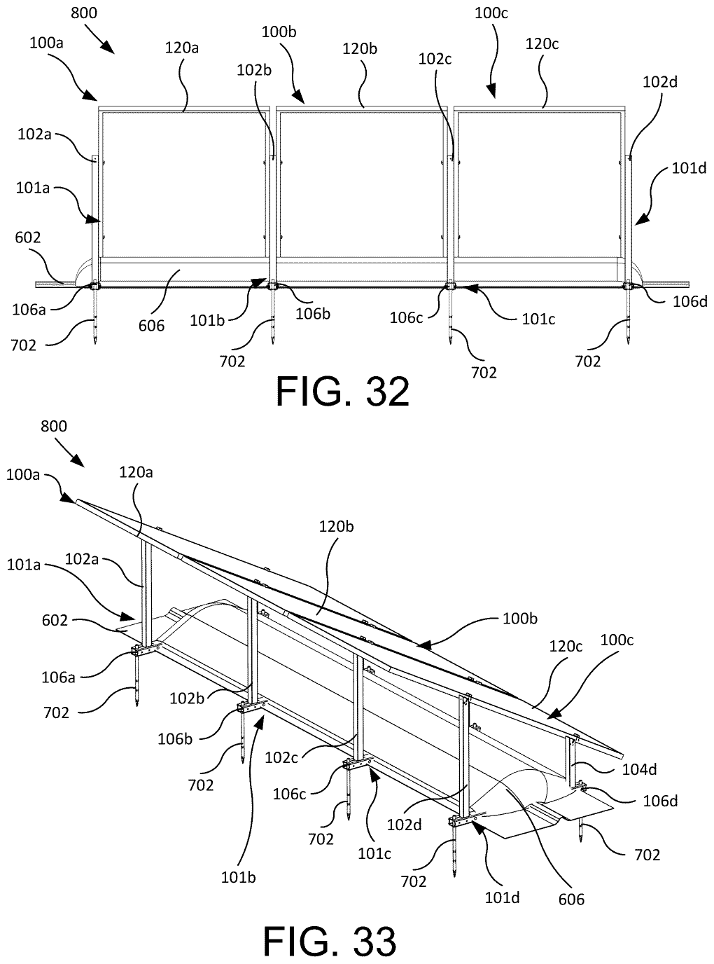

FIGS. 32-36 illustrate methods of securing a racking frame to a ground or surface according to one or more examples disclosed herein. In some examples, the solar panel racking frame 800 is secured by spikes 702 and an earth ballast, a layer of earth 606 and a flexible sheet 602, as illustrated by FIGS. 32-33. In some examples, the support frames 101a-d are secured by spikes 702 to a ground or other flat surface. In some examples, the support frames 101a-d are leveled and adjusted based on the attachment of the clamp aperture 110 to the earth spike 702. Once the support frames 101a-d are leveled, the earth ballast, as described above, is added to support frames 101a-d to secure the frames to the ground and prevent unintentional movement of the solar panel racking frame 800.

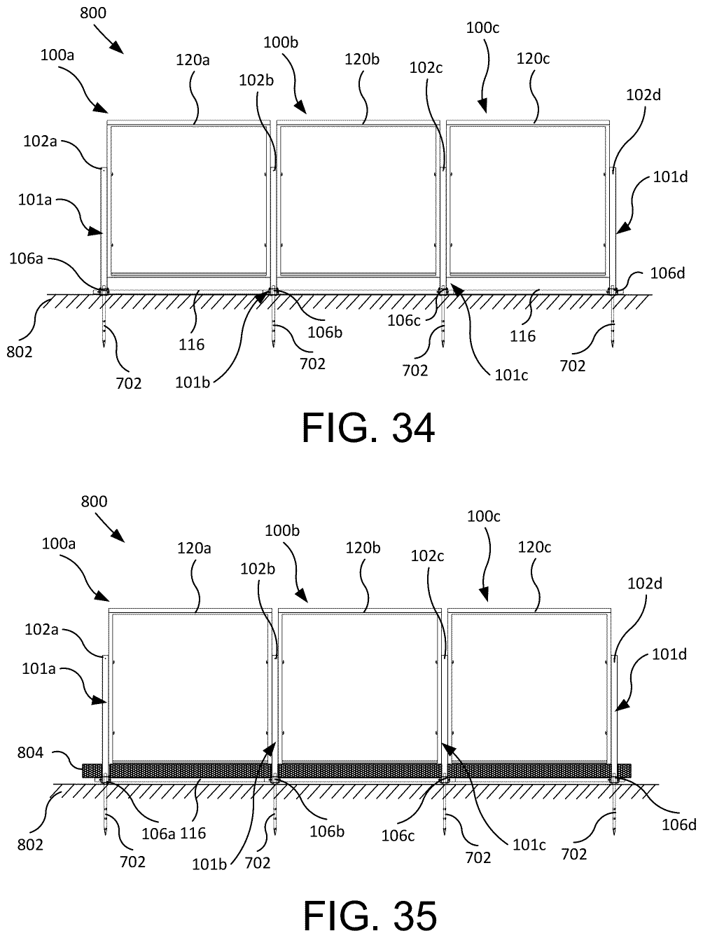

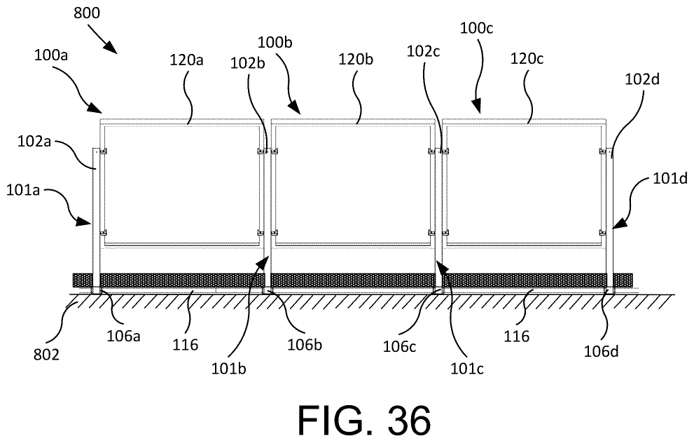

In another example, as shown in FIG. 34, the solar panel racking frame 800 is secured to a flat surface 802 using earth spikes 702. In some examples, the flat surface 802 is leveled dirt or earth. In another example, the flat surface 802 is a concrete or cement footing for the solar panel racking frame 800. In some examples, the solar panel racking frame 800 is secured using earth anchors 702 and concrete or cement ballast 804, as illustrated in FIG. 35. In some examples, the cement ballast 804 resembles a parking stop. In some examples, the cement ballast 804 may further be anchored to the ground with a steel rod, earth spike, or other anchor to further secure the solar panel racking frame 800. In yet another example, as shown in FIG. 36, the solar racking frame 800 is secured to the flat surface 802 by cement ballast 804. In some examples, the cement ballast 804 is anchored to the flat surface 802 and the solar racking frame 800, and the corresponding support frames 101a-d is not secured by additional anchors.

In some examples, the solar racking frame 800 is bolted, or secured, to a concrete footing or concrete slab. In some examples, the solar racking frame 800 does not include a spacing member 116. When the solar racking frame 800 is secured to a concrete footing, or concrete slab, the spacing member 116 is not required to provide addition strength to the support frames 101a-d. The spacing member 116 is an optional member in some examples because when the support frames 101a-d are secured to the concrete footings, or concrete slab, the support frames 101a-d are unable to rotate from a vertical position.

In some examples, the solar panel racking frame 800 capable of being efficiently disassembled, moved, and reassembled in a new location. In some examples, the solar panel racking frame 800 is a modular frame setup that can be moved and adjusted based on the needs of the owner and/or user.

The present invention pertains to solar racking frames for roof and ground mounting solar modules at a fixed or adjustable sun angle.

Previously known racking systems are generally designed to be mounted with one mounting option, e.g. concrete footings, ballast bins, or post pounded posts, and they usually utilize horizontal solar mounting rails and clamps to secure the solar modules to the rack frame. These types of systems use an excess of parts and fasteners. In many cases of racking systems, the system requires concrete footings or dirt to be shoveled by hand into a plastic bin for a ballast. One problem in many racking systems is that the parts are heavy or excessively large to ship around the country, and the racking systems limit the solar module sizes that can be accommodated by the racking system.

The present invention in certain embodiments solves in the above described issues and is not limited to one mounting option. The present invention in the given examples utilizes the solar panels own structural strength to eliminate the need for solar rails or upper rack frame horizontal members. This concept drastically reduces the parts and fasteners required to rack solar modules. A further advantage is that each modular U-shaped frame is spaced by the solar panel itself, so the frame will accommodate solar modules of any width and height.

Additional advantages of the modular solar racking frame is that the support frame is modular and in some examples, the support frame can be separated into multiple parts. The multiple parts can be disassembled and shipped resulting in lower shipping costs.

The modular support frame can in additional examples of installation be directly bolted or secured to a concrete ballast slab, concrete footings, or bolted to a roof beam. These modular support frames can be spaced apart with at least one spacing member, such as a pipe, tube, or other base structure to allow for multiple types of direct ground mounting systems.

In one example, the modular support frames are secured by earth ballast. The earth ballast includes a geofabric, or other thin strong material, which is adhesively applied to a top side of the bottom connecting frame member to create a large foot base for earth fill, or concrete, to be poured directly onto the ballasting the support frame. The geofabric, or other thin strong material, may be adhesively applied with fast setting epoxy to the top side of the base connecting member to create a large foot base. The geofabric is pulled tight from modular frame to modular frame and is slightly elevated off the ground by the frame members or other means such that as the earth fill, or concrete, is placed on top of the geofabric the earth fill stretches the geofabric with great force and pulls the support frames tightly to the ground. This prevents the frame from pulling up under high winds and just the earth mound away from the support frame, in an effect like putting dirt pile on a trampoline and trying to move the trampoline with all of the weight bearing down on the interconnected support frames all at once.

Another feature in some examples is that the bottom connecting member of the support frame has the ability to clamp directly onto steel stakes, or earth spikes, with the bottom connecting member clamp feature. This allows for an alternate, or additional, method of securing the support frame to a ground surface. The steel stake or spike can be hammered into the ground or into pre-drilled holes. In one example, the spikes include a channel with side openings. Once in the ground, the spike is filled with an expanding foam or epoxy resin to form barbs along the length of the anchor spike tube. Gravity forces the resin out of the barb hole openings along the length of the anchor spike tube and allows the resin to penetrate the soil and fill voids surrounding the anchor spike and form hard bulges or nodes. The bulges or nodes of the hardened epoxy and soil are excellent earth anchors and provide in some soil types much better anchoring capabilities. The epoxy earth anchor spikes do not require years of soil compaction around the base of the frame to hold maximum hold down capabilities. The anchor spikes are solidly held in place once the epoxy fully cures.

The modular solar racking frame further provides a ballast support rail out of each of the frame members where concrete blocks, water tanks, or other materials, can provide sufficient weight for holding the frames down in high winds.

The frame and anchors further provide leveling capabilities using a steel stake, or earth spike, for uneven terrain. In some examples, the clamp aperture in the ends of a tubular bottom connecting member allows for the support frame to clamp onto the steel stakes, or earth spike, to adjust the height by tightening a bolt to the clamp the frame at the desired height above the ground.

In the above description, certain terms may be used such as “up,” “down,” “upper,” “lower,” “horizontal,” “vertical,” “left,” “right,” “over,” “under” and the like. These terms are used, where applicable, to provide some clarity of description when dealing with relative relationships. But, these terms are not intended to imply absolute relationships, positions, and/or orientations. For example, with respect to an object, an “upper” surface can become a “lower” surface simply by turning the object over. Nevertheless, it is still the same object. Further, the terms “including,” “comprising,” “having,” and variations thereof mean “including but not limited to” unless expressly specified otherwise. An enumerated listing of items does not imply that any or all of the items are mutually exclusive and/or mutually inclusive, unless expressly specified otherwise. The terms “a,” “an,” and “the” also refer to “one or more” unless expressly specified otherwise. Further, the term “plurality” can be defined as “at least two.”

Additionally, instances in this specification where one element is “coupled” to another element can include direct and indirect coupling. Direct coupling can be defined as one element coupled to and in some contact with another element. Indirect coupling can be defined as coupling between two elements not in direct contact with each other, but having one or more additional elements between the coupled elements. Further, as used herein, securing one element to another element can include direct securing and indirect securing. Additionally, as used herein, “adjacent” does not necessarily denote contact. For example, one element can be adjacent another element without being in contact with that element.

As used herein, the phrase “at least one of” when used with a list of items, means different combinations of one or more of the listed items may be used and only one of the items in the list may be needed. The item may be a particular object, thing, or category. In other words, “at least one of” means any combination of items or number of items may be used from the list, but not all of the items in the list may be required. For example, “at least one of item A, item B, and item C” may mean item A; item A and item B; item B; item A, item B, and item C; or item B and item C. In some cases, “at least one of item A, item B, and item C” may mean, for example, without limitation, two of item A, one of item B, and ten of item C; four of item B and seven of item C; or some other suitable combination.

Unless otherwise indicated, the terms “first,” “second,” etc. are used herein merely as labels, and are not intended to impose ordinal, positional, or hierarchical requirements on the items to which these terms refer. Moreover, reference to, e.g., a “second” item does not require or preclude the existence of, e.g., a “first” or lower-numbered item, and/or, e.g., a “third” or higher-numbered item.

As used herein, a system, apparatus, structure, article, element, component, or hardware “configured to” perform a specified function is indeed capable of performing the specified function without any alteration, rather than merely having potential to perform the specified function after further modification. In other words, the system, apparatus, structure, article, element, component, or hardware “configured to” perform a specified function is specifically selected, created, implemented, utilized, programmed, and/or designed for the purpose of performing the specified function. As used herein, “configured to” denotes existing characteristics of a system, apparatus, structure, article, element, component, or hardware which enable the system, apparatus, structure, article, element, component, or hardware to perform the specified function without further modification. For purposes of this disclosure, a system, apparatus, structure, article, element, component, or hardware described as being “configured to” perform a particular function may additionally or alternatively be described as being “adapted to” and/or as being “operative to” perform that function.

The schematic flow chart diagrams included herein are generally set forth as logical flow chart diagrams. As such, the depicted order and labeled steps are indicative of one example of the presented method. Other steps and methods may be conceived that are equivalent in function, logic, or effect to one or more steps, or portions thereof, of the illustrated method. Additionally, the format and symbols employed are provided to explain the logical steps of the method and are understood not to limit the scope of the method. Although various arrow types and line types may be employed in the flow chart diagrams, they are understood not to limit the scope of the corresponding method. Indeed, some arrows or other connectors may be used to indicate only the logical flow of the method. For instance, an arrow may indicate a waiting or monitoring period of unspecified duration between enumerated steps of the depicted method. Additionally, the order in which a particular method occurs may or may not strictly adhere to the order of the corresponding steps shown.

The present subject matter may be embodied in other specific forms without departing from its spirit or essential characteristics. The described examples are to be considered in all respects only as illustrative and not restrictive. All changes which come within the meaning and range of equivalency of the claims are to be embraced within their scope.

What is claimed is:

1. A support frame comprising:
a bottom connecting member provided with an aperture for adjustably receiving a spacing member;
a first vertical support member vertically disposed on a first end of the bottom connecting member and having a mounting mechanism for connecting to a panel; and
a second vertical support member vertically disposed opposite the first vertical support member on a second end of the bottom connecting member parallel to the first vertical support member and spaced apart from the first vertical support member, the second vertical support member having a mounting mechanism for connecting to the panel.

2. The support frame of claim 1, wherein the panel comprises a solar panel.

3. The support frame of claim 1, wherein the support frame comprises a first support frame and further comprising a second support frame and wherein the spacing member is connectable between the first support frame and the second support frame such that distance between the first support frame and the second support frame is adjustable.

4. The support frame of claim 3, wherein the spacing member is secured to the first support frame and the spacing member is secured to the second support frame such that the distance between the first support frame and the second support frame is approximately the width of the panel.

5. The support frame of claim 1, wherein the bottom connecting member further includes at least one aperture of the first end of the bottom connecting member adapted for securing the support frame to a ground surface and at least one aperture of the second end of the bottom connecting member is adapted for securing the support frame to the ground surface.

6. The support frame of claim 5, wherein the at least one aperture of the first end is coupled to a first earth anchor wherein the first earth anchor is secured to the ground surface and the at least one aperture of the second end is coupled to a second earth anchor wherein the second earth anchor is secured to the ground surface.

7. The support frame of claim 6, wherein the at least one aperture of the first end and the at least one aperture of the second end further comprises a series of ridges along an inside each of the apertures to further couple the bottom connecting member to the first earth anchor and second earth anchor.

8. The support frame of claim 7, wherein the support frame comprises a first support frame and further comprising a second support frame and wherein the spacing member is coupled between the first support frame and the second support frame such that distance between the first support frame and the second support frame is the width of the panel.

9. The support frame of claim 1, wherein the support frame further comprises a flexible sheet disposed across the spacing member, the flexible sheet is coupled to the first support frame and the second support frame.

10. The support frame of claim 9, wherein a layer of earth is applied across the top of the flexible sheet.

11. The support frame of claim 1, wherein the bottom connecting member, the first vertical support member, and the second vertical support member are tubular.

12. The support frame of claim 1, wherein the bottom connecting member, the first vertical support member, and the second vertical support member are made of a metal composite.

13. A reconfigurable solar panel system, comprising:
at least one solar panel; and
a plurality of repeating frames coupled to each side of the at least one solar panel, wherein each of the repeating frames comprises:
a bottom connecting member provided with an aperture for adjustably receiving a spacing member;
a first vertical support member vertically disposed on a first end of the bottom connecting member and having a mounting mechanism for connecting to the at least one solar panel; and
a second vertical support member vertically disposed opposite the first vertical support member on a second end of the bottom connecting member parallel to the first vertical support member and spaced apart from the first vertical support member, the second vertical support member having a mounting mechanism for connecting to the at least one solar panel.

14. The reconfigurable solar panel system of claim 13, wherein the spacing member is coupled between a first repeating frame and a second repeating frame such that a distance between the first repeating frame and the second repeating frame is a width of the at least one solar panel.

15. The reconfigurable solar panel system of claim 14, wherein the bottom connecting member of the plurality of repeating frames further includes at least one aperture of the first end of the bottom connecting member adapted for securing the support frame to a ground surface and at least one aperture of the second end of the bottom connecting member is adapted for securing the support frame to the ground surface.

16. The reconfigurable solar panel system of claim 15, wherein the at least one aperture of the first end is coupled to a first earth anchor wherein the first earth anchor is secured to the ground surface and the at least one aperture of the second end is coupled to a second earth anchor wherein the second spike is secured to the ground surface.

17. The reconfigurable solar panel system of claim 16, wherein the at least one aperture of the first end and the at least one aperture of the second end further comprises a series of ridges along an inside each of the apertures to further couple the bottom connecting member to the first earth anchor and second earth anchor.

18. The reconfigurable solar panel system of claim 13, wherein the plurality of repeating frames further comprises a flexible sheet disposed across the spacing member and wherein the flexible sheet is coupled to the first support frame and the second support frame.

19. The reconfigurable solar panel of claim 18, further comprising a layer of earth disposed across the top of the flexible sheet.

20. A reconfigurable solar panel system, comprising:
at least one solar panel;
a plurality of repeating frames coupled to each side of the at least one solar panel, wherein each of the repeating frames comprises:
a bottom connecting member provided with an aperture for adjustably receiving a spacing member;
a first vertical support member vertically disposed on a first end of the bottom connecting member and having a mounting mechanism for connecting to the at least one solar panel;
a second vertical support member vertically disposed opposite the first vertical support member on a second end of the bottom connecting member parallel to the first vertical support member and spaced apart from the first vertical support member, the second vertical support member having a mounting mechanism for connecting to the at least one solar panel;
the spacing member connectable between the plurality of repeating frames such that the distance between a first repeating frame and a second repeating frame is a width of the at least one solar panel; and
a flexible sheet disposed across the plurality of repeating frames and the spacing member, wherein the flexible sheet is coupled to the plurality of repeating frames with an adhesive and wherein a layer of earth is applied across the top of the flexible sheet.
